(19) United States
(12) Patent Application Publication
(10) Pub. No.: US 2024/0426402 A1
(43) Pub. Date: Dec. 26, 2024

(54) PFAS-FREE THERMOPLASTIC MULTILAYER FUEL LINE

(71) Applicant: Dennis M. D’HONDT, Ray, MI (US)

(72) Inventor: Dennis M. D’HONDT, Ray, MI (US)

(73) Assignee: GM GLOBAL TECHNOLOGY OPERATIONS LLC, Detroit, MI (US)

(21) Appl. No.: 18/339,377

(22) Filed: Jun. 22, 2023

(51) Int. Cl. F16L 11/04; F16L 11/12

(52) U.S. Cl. CPC F16L 11/045; F16L 11/12; B32B 1/08; B32B 7/12; B32B 27/08; B32B 27/20; B32B 27/306; B32B 27/34; B32B 2250/04; B32B 2250/05; B32B 2250/24; B32B 2264/108; B32B 2307/202; B32B 2307/206; B32B 2307/714; B32B 2597/00

(57) ABSTRACT

A multilayer fuel line includes a liner layer, a barrier layer circumferentially surrounding the liner layer, and a cover layer circumferentially surrounding the barrier layer. The liner layer comprises polyterephthalamide and has an inner circumferential surface defining a tubular flowthrough passage extending in an axial direction through the multilayer fuel line. The inner circumferential surface of the liner layer has a surface resistivity of less than or equal to about 1×10⁶ Ohms per square at 20 degrees Celsius. The barrier layer comprises ethylene vinyl alcohol. The cover layer defines an outer circumferential surface of the multilayer fuel line and comprises an aliphatic polyamide.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to layered thermoplastic tubing for conveyance of fuels.

Tubes or lines used for conveyance of liquid fuels are oftentimes made of thermoplastic materials and may have a layered structure that provides the lines with a desirable combination of electrical conductivity, low fuel permeability, high chemical and thermal resistance, wear resistance, light weight, mechanical robustness, and flexibility over a desired operating temperature range.

### SUMMARY

A multilayer fuel line is disclosed. The multilayer fuel line comprises a liner layer, a barrier layer circumferentially surrounding the liner layer, and a cover layer circumferentially surrounding the barrier layer. The liner layer has an inner circumferential surface defining a tubular flowthrough passage extending in an axial direction through the multilayer fuel line. The liner layer comprises polyterephthalamide. The inner circumferential surface of the liner layer has a surface resistivity of less than or equal to about 1×10⁶ Ohms per square at 20 degrees Celsius. The barrier layer comprises ethylene vinyl alcohol. The cover layer defines an outer circumferential surface of the multilayer fuel line. The cover layer comprises an aliphatic polyamide.

In aspects, the liner layer may comprise poly(nonamethylene terephthalamide).

The liner layer may be substantially free of esters and amides having molecular weights of less than or equal to about 2000.

The liner layer may comprise a continuous matrix phase and a dispersed phase distributed throughout the continuous matrix phase. The continuous matrix phase may comprise the polyterephthalamide and the dispersed phase may comprise an electrically conductive agent.

In aspects, the electrically conductive agent may comprise carbon.

The continuous matrix phase may constitute, by weight, greater than or equal to about 80% to less than or equal to about 99.8% of the liner layer. The electrically conductive agent may constitute, by weight, greater than or equal to about 0.2% to less than or equal to about 20% of the liner layer.

The liner layer may comprise an electrically conductive inner layer and an electrically insulating outer layer circumferentially surrounding the inner layer. The electrically conductive inner layer may define the inner circumferential surface of the liner layer and may comprise a continuous matrix phase comprising polyterephthalamide and a dispersed phase comprising an electrically conductive agent. The electrically insulating outer layer may comprise polyterephthalamide and may have a surface resistivity of greater than 1×10⁶ Ohms per square at 20 degrees Celsius.

The multilayer fuel line may further comprise an intermediate layer circumferentially surrounding the liner layer and being disposed between the liner layer and the barrier layer. The intermediate layer may comprise an aliphatic polyamide.

In aspects, the intermediate layer may comprise poly(dodecano-12-lactam).

The intermediate layer may be directly physically and chemically bonded to the liner layer without use of an adhesive.

The barrier layer may create a seal around the tubular flowthrough passage that prevents fuel vapors from permeating through the multilayer fuel line and escaping to an external ambient environment.

In aspects, the cover layer may comprise poly(dodecano-12-lactam), poly(hexamethylene dodecanediamide), or a combination thereof.

The multilayer fuel line may further comprise a first adhesive layer disposed between the liner layer and the barrier layer that physically bonds the barrier layer to the liner layer, and a second adhesive layer disposed between the barrier layer and the cover layer that physically bonds the cover layer to the barrier layer. The first and second adhesive layers each may comprise a thermoplastic polymer.

The multilayer fuel line may be substantially free of perfluoroalkyl substances, polyfluoroalkyl substances, and combinations thereof.

The multilayer fuel line may be configured to withstand temperatures in a range of greater than or equal to about-40 degrees Celsius to less than or equal to about 130 degrees Celsius.

A multilayer fuel line according to one or more embodiments of the present disclosure comprises a liner layer, an intermediate layer circumferentially surrounding the liner layer, a barrier layer circumferentially surrounding the intermediate layer, and a cover layer circumferentially surrounding the barrier layer. The liner layer has an inner circumferential surface defining a tubular flowthrough passage extending in an axial direction through the multilayer fuel line. The intermediate layer comprises an aliphatic polyamide. The barrier layer comprises ethylene vinyl alcohol. The cover layer defines an outer circumferential surface of the multilayer fuel line and comprises an aliphatic polyamide. The liner layer has a composite structure comprising a continuous matrix phase and a dispersed phase distributed throughout the continuous matrix phase. The continuous matrix phase comprises poly(nonamethylene terephthalamide) and the dispersed phase comprises an electrically conductive agent. The electrically conductive agent provides the inner circumferential surface of the liner layer with a surface resistivity of less than or equal to about 1×10⁶ Ohms per square at 20 degrees Celsius.

The poly(nonamethylene terephthalamide) of the liner layer may provide the inner circumferential surface of the liner layer with chemical resistance and low oligomer extraction against volatile liquid fuels.

The barrier layer may create a seal that circumferentially surrounds the tubular flowthrough passage and prevents fuel vapors from permeating through the multilayer fuel line and escaping to an external ambient environment.

The intermediate layer, the barrier layer, and the cover layer may be electrically insulating and may have surface resistivities of greater than 1×10⁶ Ohms per square at 20 degrees Celsius.

The multilayer fuel line may be substantially free of perfluoroalkyl substances, polyfluoroalkyl substances, and combinations thereof.

The multilayer fuel line may be configured to withstand temperatures in a range of greater than or equal to about −40 degrees Celsius to less than or equal to about 130 degrees Celsius.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic cross-sectional view of a multilayer fuel line according to one or more embodiments of the present disclosure.

FIG. 2 is a schematic cross-sectional view of a multilayer fuel line according to another embodiment of the present disclosure.

In the drawings, reference numbers may be reused to identify similar and/or identical elements.

### DETAILED DESCRIPTION

A multilayer fuel line according to the present disclosure comprises a laminate of thermoplastic polymer layers including an electrically conductive polyterephthalamide liner layer. The polyterephthalamide liner layer provides the multilayer fuel line with low fuel permeability, high chemical and thermal resistance over a wide operating temperature range, high strength, dimensional stability, low oligomer extraction against fuel, and electrical conductivity, without the use of per- or polyfluoroalkyl substances (PFAS), e.g., perfluorooctanoic acid (PFOA), perfluorooctane sulfonate (PFOS), polytetrafluoroethylene (PTFE), and combinations thereof. The polyterephthalamide liner layer may be used in combination with a ethylene vinyl alcohol barrier layer and an aliphatic polyamide cover layer to provide a light weight multilayer fuel line that exhibits exceptional chemical, thermal, and mechanical properties at relatively low cost, as compared to multilayer fuel lines that rely on PFAS for sufficient chemical and thermal resistance.

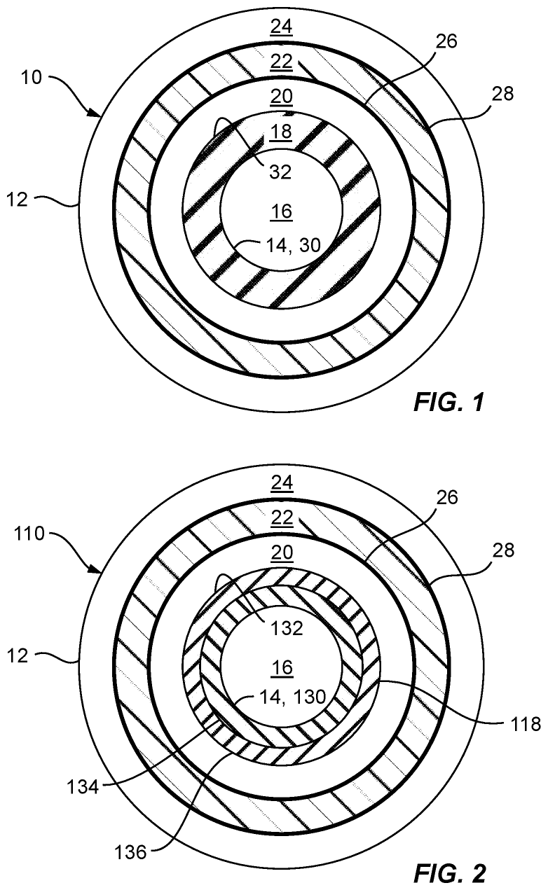

Referring now to FIG. 1, a multilayer fuel line 10 has an outer circumferential surface 12 and an inner circumferential surface 14 defining a tubular flowthrough passage 16 extending in an axial direction therethrough. The multilayer fuel line 10 includes a liner layer 18, an optional intermediate layer 20, a barrier layer 22, a cover layer 24, and optional first and second adhesive layers 26, 28. The multilayer fuel line 10 may be used for conveying or carrying liquid fuel, vaporous fuel, or a combination thereof. For example, the multilayer fuel line 10 may be used for conveying or carrying volatile liquid fuels and/or heavy liquid fuels (e.g., diesel fuel). Examples of volatile liquid fuels include gasoline and/or aliphatic alcohols, e.g., methanol, ethanol, propanol, and/or butanol. In aspects, the multilayer fuel line 10 may be used in automotive vehicles and may have an operating temperature range of from about −40 degrees Celsius (° C.) to about 130° C. The multilayer fuel line 10 may have a thickness, defined between the outer circumferential surface 12 and the inner circumferential surface 14, of greater than or equal to about 1 millimeter (mm) to less than or equal to about 5 mm.

The liner layer 18 is the innermost layer of the multilayer fuel line 10 and is configured to be electrically conductive and to create a physical barrier that prevents fuel flowing in the tubular flowthrough passage 16 from penetrating, permeating, or decomposing the multilayer fuel line 10. The liner layer 18 has an inner surface 30 and an opposite outer surface 32, with the inner surface 30 defining the inner circumferential surface 14 of the multilayer fuel line 10. The liner layer 18 has a composite structure comprising a continuous matrix phase and a dispersed phase distributed throughout the continuous matrix phase. The continuous matrix phase may constitute, by weight, greater than or equal to about 80%, optionally about 90%, or optionally about 95% to less than or equal to about 99.8%, optionally about 99%, or optionally about 97% of the liner layer 18. The dispersed phase may constitute, by weight, greater than or equal to about 0.2%, optionally about 1%, or optionally about 3% to less than or equal to about 20%, optionally about 10%, or optionally about 5% of the liner layer 18.

The continuous matrix phase comprises polyterephthalamide. In aspects, the continuous matrix phase may consist essentially of or consist of polyterephthalamide. The polyterephthalamide is a partially aromatic and partially crystalline polyamide. The polyterephthalamide provides the liner layer 18 with exceptional thermal and chemical resistance, strength, wear and abrasion resistance, as well as good processability for extrusion and injection molding applications. In particular, the polyterephthalamide provides the liner layer 18 with high chemical resistance against fuels and has low oligomer extraction or leaching of oligomers therefrom upon contact with fuel, especially at high operating temperatures. The extraction or leaching of oligomers from fuel system components, e.g., fuel lines, can result in contamination of the fuel and/or clogging of the fuel system components. In aspects, the liner layer 18 may comprise poly(nonamethylene terephthalamide), also known as PA9T. The polyterephthalamide may constitute, by weight, greater than or equal to about 80%, optionally about 90%, or optionally about 95% to less than or equal to about 99.8%, optionally about 99%, or optionally about 97% of the liner layer 18.

The dispersed phase comprises an electrically conductive agent. The electrically conductive agent is distributed throughout at least a portion of the liner layer 18 and provides the liner layer 18 with desired electrical conductivity. For example, the electrically conductive agent may provide the liner layer 18 with a surface resistivity of less than or equal to about 1×10⁶ Ohms per square (Ohm/sq), or optionally less than or equal to about 1×10⁵ Ohm/sq at 20 degrees Celsius (° C.). The electrically conductive agent may be distributed substantially uniformly throughout the continuous matrix phase or the concentration of the electrically conductive agent may vary within the composite structure of the liner layer 18. For example, in aspects, the concentration of the electrically conductive agent may be relatively high in regions of the liner layer 18 disposed along the inner circumferential surface 14 of the multilayer hose 10 and relatively low in regions of the liner layer 18 disposed along the outer surface 32 of the liner layer 18. The electrically conductive agent may comprise particles of a carbon-based material, an electrically conductive polymer, or a combination thereof. Examples of electrically conductive carbon-based materials include carbon black (e.g., acetylene black), graphite, graphene (e.g., graphene nanoplatelets), carbon nanotubes (e.g., single-walled and/or multiwalled carbon nanotubes), carbon fibers (e.g., carbon nanofibers), and/or Ketjenblack®. Examples of electrically conductive polymers include polyaniline, polythiophene, polyacetylene, and/or polypyrrole. The electrically conductive agent may constitute, by weight, greater than or equal to about 0.2%, optionally about 1%, or optionally about 3% to less than or equal to about 20%, optionally about 10%, or optionally about 5% of the liner layer 18.

The liner layer 18 may be substantially free of additives and residual monomers and/or oligomers having molecular weights of less than or equal to about 2000, optionally about 1000, or optionally about 100. Low molecular weight additives are oftentimes included in polymeric materials (e.g., polyamides) to provide the materials with desirable processing characteristics and/or low temperature performance (e.g., impact strength). Examples of such additives include antioxidants (e.g., tris(2,4-di-tert butyl phenyl) phosphite), surfactants, slip agents, plasticizers (e.g., esters and/or amides), acid scavengers, crosslinking agents, and lubricants. For example, the liner layer 18 may be substantially free of ester plasticizers and amide plasticizers having molecular weights of less than or equal to about 2000, optionally about 1000, or optionally about 100. Specific examples of ester plasticizers include phthalic acid esters (phthalates, e.g., dibutyl phthalate and/or dioctyl phthalate), fatty acid esters, polyhydric alcohol esters, phosphoric acid esters, trimellitic acid esters (trimellitates), and hydroxybenzoic acid esters. Specific examples of amide plasticizers include sulfonamides, for example, benzene sulfonamide (e.g., N-butyl benzene sulfonamide) and/or toluene sulfonamide. In aspects, the liner layer 18 may be substantially free of amide monomers and/or oligomers having molecular weights of less than or equal to about 2000, optionally about 1000, or optionally about 100.

The liner layer 18 may be substantially free of perfluoroalkyl substances, polyfluoroalkyl substances, and combinations thereof. For example, the liner layer 18 may be substantially free of PTFE. The liner layer 18 may have a thickness, defined between the inner surface 30 and the outer surface 32, of greater than or equal to about 0.1 mm to less than or equal to about 1 mm.

The optional intermediate layer 20 circumferentially surrounds the liner layer 18 and is disposed between the liner layer 18 and the barrier layer 22. The intermediate layer 20 may be electrically insulating and is configured to provide the multilayer fuel line 10 with rigidity and/or to ensure good bonding between the liner layer 18 and the barrier layer 22. The intermediate layer 20 comprises an aliphatic polyamide. For example, the intermediate layer 20 may comprise poly(dodecano-12-lactam), also known as PA12. The intermediate layer 20 may be directly physically and chemically bonded to the liner layer 18 without use of an adhesive.

The barrier layer 22 circumferentially surrounds the liner layer 18 and is disposed between the liner layer 18 and the cover layer 24. In aspects where the multilayer fuel line 10 comprises the intermediate layer 20, the barrier layer 22 is disposed between the intermediate layer 20 and the cover layer 24. The barrier layer 22 may be electrically insulating and is configured to create a seal around the tubular flowthrough passage 16 that prevents gases and/or vapors from permeating through the multilayer fuel line 10 and escaping to an external ambient environment. The barrier layer 22 may comprise ethylene vinyl alcohol (EVOH).

The cover layer 24 is the outermost layer of the multilayer fuel line 10 and circumferentially surrounds the barrier layer 22. The cover layer 24 may be electrically insulating and is configured to provide the multilayer fuel line 10 with flexibility, durability, and resistance to abrasion, wear, impacts, and weathering (e.g., resistance to ozone, ultraviolet light, and hydrolysis). The cover layer 24 comprises an aliphatic polyamide. For example, the cover layer 24 may comprise poly(dodecano-12-lactam) (also known as PA12), poly(hexamethylene dodecanediamide) (also known as Nylon 6, 12 or PA612), or a combination thereof.

The optional first adhesive layer 26 is disposed between the liner layer 18 and the barrier layer 22 and provides a strong physical bond therebetween. In aspects where the multilayer fuel line 10 comprises the intermediate layer 20, the first adhesive layer 26 is disposed between the intermediate layer 20 and the barrier layer 22 and provides a strong physical bond therebetween. The first adhesive layer 26 comprises a polyolefin resin. The specific composition of the polyolefin resin may be selected based on the composition of the liner layer 18 and the barrier layer 22 and/or of the intermediate layer 20 and the barrier layer 22.

The optional second adhesive layer 28 is disposed between the barrier layer 22 and the cover layer 24 and provides a strong physical bond therebetween. The second adhesive layer 28 may comprise a thermoplastic polymer, e.g., a polyolefin resin. The specific composition of the thermoplastic polymer may be selected based on the composition of the barrier layer 22 and the cover layer 24.

In aspects, the multilayer fuel line 10 may consist of the liner layer 18, the barrier layer 22, and the cover layer 24 and may be free of any additional layers underlying the liner layer 18, overlying the cover layer 24, disposed between the liner layer 18 and the barrier layer 22, or disposed between the barrier layer 22 and the cover layer 24. In other aspects, the multilayer fuel line 10 may consist of the liner layer 18, the intermediate layer 20, the barrier layer 22, the cover layer 24, and the first and second adhesive layers 26, 28 and may be free of any additional layers underlying the liner layer 18, overlying the cover layer 24, or disposed between the liner layer 18 and the cover layer 24.

FIG. 2 depicts another embodiment of a multilayer fuel line 110. The multilayer fuel line 110 is similar in many respects to the multilayer fuel line 10 and like numerals between the embodiments generally designate like or corresponding elements in the drawing figures. Accordingly, the description of the multilayer fuel line 10 is incorporated into that of the multilayer fuel line 110, and description of subject matter common to the multilayer fuel line 10 and the multilayer fuel line 110 generally may not be repeated here.

The multilayer fuel line 110 includes a liner layer 118, an optional intermediate layer 20, a vapor barrier layer 22, a cover layer 24, and optional first and second adhesive layers 26, 28. The liner layer 118 is the innermost layer of the multilayer fuel line 110 and has an inner surface 130 and an opposite outer surface 132, with the inner surface 130 defining the inner circumferential surface 14 of the multilayer fuel line 110. The liner layer 118 has a bilayer structure comprising an inner layer 134 and an outer layer 136 circumferentially surrounding the inner layer 134. The inner layer 134 of the liner layer 118 defines the inner surface 130 of the liner layer 118 and the inner circumferential surface 14 of the multilayer fuel line 110. The outer layer 136 defines the outer surface 132 of the liner layer 118. The inner layer 134 is electrically conductive and may have substantially the same chemical composition and physical properties as that of the liner layer 18. On the other hand, the outer layer 136 is electrically insulating and may have substantially the same composition as that of the continuous matrix phase of the liner layer 18. For example, the outer layer 136 may comprise, consist essentially of, or consist of polyterephthalamide (e.g., poly(nonamethylene terephthalamide)). The outer layer 136 may be substantially free of the electrically conductive agent. The outer layer 136 may have a surface resistivity of greater than 1×10⁶ Ohm/sq, or optionally greater than or equal to about 1×10¹⁴ Ohm/sq at 20° C.

In aspects, the multilayer fuel line 110 may consist of the liner layer 118, the barrier layer 22, and the cover layer 24 and may be free of any additional layers underlying the liner layer 118, overlying the cover layer 24, disposed between the liner layer 118 and the barrier layer 22, or disposed between the barrier layer 22 and the cover layer 24. In other aspects, the multilayer fuel line 110 may consist of the liner layer 118, the intermediate layer 20, the barrier layer 22, the cover layer 24, and the first and second adhesive layers 26, 28 and may be free of any additional layers underlying the liner layer 118, overlying the cover layer 24, or disposed between the liner layer 118 and the cover layer 24.

The multilayer fuel line 10, 110 may be manufactured via an extrusion process, e.g., a coextrusion process. In an extrusion process, a material having the same composition as that of one of the layers (e.g., 18, 20, 22, 24) is melted, fed to an extruder, and forced through a die at high temperature and pressure to from one of the layers. In a coextrusion process, multiple molten materials having different compositions corresponding to the different layers (e.g., 18, 22, and 24) may be fed into separate extruders and then forced through a single die, where the molten materials are combined and deposited concentrically and simultaneously around and over each other such that the layers adhere to each other and produce the multilayer fuel line 10, 110. Alternatively, one or more of the interior layers (e.g., 18 and/or 22) of the multilayer fuel line 10, 110 may be preformed (e.g., by extrusion) and then one or more of the surrounding layers (e.g., 22 and/or 24) may be formed over and concentrically around the one or more preformed interior layers. In some aspects, the multilayer fuel line 10, 110 may be manufactured via multiple extrusion and/or coextrusion processes. Prior to extrusion (or coextrusion) the starting materials may be dried to remove residual water content therefrom.

During the extrusion process, the thickness of the layers (e.g., 18, 20, 22, 24) may be measured (e.g., by a laser) and controlled or adjusted by control or adjustment of the extruder settings as layers are extruded. The multilayer fuel line 10, 110 may be cooled as it exits the extruder and either placed into coils or cut to a desired length. Each cut length of the multilayer fuel line 10, 110 may be placed in a form to take a preconfigured shape and heated (e.g., on a belt proceeding through an oven) to soften and conform the multilayer fuel line 10, 110 to the shape induced by the form. After the formed multilayer fuel line 10, 110 is cooled, a fitting may be press-fit into an open end thereof to form a finished fuel line assembly.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value.

“About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A multilayer fuel line comprising:
a liner layer having an inner circumferential surface defining a tubular flowthrough passage extending in an axial direction through the multilayer fuel line, the liner layer comprising polyterephthalamide, the inner circumferential surface of the liner layer having a surface resistivity of less than or equal to about 1×10⁶ Ohms per square at 20 degrees Celsius;
a barrier layer circumferentially surrounding the liner layer, the barrier layer comprising ethylene vinyl alcohol; and
a cover layer circumferentially surrounding the barrier layer and defining an outer circumferential surface of the multilayer fuel line, the cover layer comprising an aliphatic polyamide.

2. The multilayer fuel line of claim 1, wherein the liner layer comprises poly(nonamethylene terephthalamide).

3. The multilayer fuel line of claim 1, wherein the liner layer is substantially free of esters and amides having molecular weights of less than or equal to about 2000.

4. The multilayer fuel line of claim 1, wherein the liner layer comprises:
a continuous matrix phase; and
a dispersed phase distributed throughout the continuous matrix phase,
wherein the continuous matrix phase comprises the polyterephthalamide and the dispersed phase comprises an electrically conductive agent.

5. The multilayer fuel line of claim 4, wherein the electrically conductive agent comprises carbon.

6. The multilayer fuel line of claim 4, wherein the continuous matrix phase constitutes, by weight, greater than or equal to about 80% to less than or equal to about 99.8% of the liner layer, and wherein the electrically conductive agent constitutes, by weight, greater than or equal to about 0.2% to less than or equal to about 20% of the liner layer.

7. The multilayer fuel line of claim 1, wherein the liner layer comprises:
an electrically conductive inner layer defining the inner circumferential surface of the liner layer and comprising a continuous matrix phase comprising polyterephthalamide and a dispersed phase comprising an electrically conductive agent; and
an electrically insulating outer layer circumferentially surrounding the inner layer, the electrically insulating outer layer comprising polyterephthalamide and having a surface resistivity of greater than 1×10⁶ Ohms per square at 20 degrees Celsius.

8. The multilayer fuel line of claim 1, further comprising:
an intermediate layer circumferentially surrounding the liner layer and being disposed between the liner layer and the barrier layer, the intermediate layer comprising an aliphatic polyamide.

9. The multilayer fuel line of claim 8, wherein the intermediate layer comprises poly(dodecano-12-lactam).

10. The multilayer fuel line of claim 8, wherein the intermediate layer is directly physically and chemically bonded to the liner layer without use of an adhesive.

11. The multilayer fuel line of claim 1, wherein the barrier layer creates a seal around the tubular flowthrough passage that prevents fuel vapors from permeating through the multilayer fuel line and escaping to an external ambient environment.

12. The multilayer fuel line of claim 1, wherein the cover layer comprises poly(dodecano-12-lactam), poly(hexamethylene dodecanediamide), or a combination thereof.

13. The multilayer fuel line of claim 1, wherein the multilayer fuel line is substantially free of perfluoroalkyl substances, polyfluoroalkyl substances, and combinations thereof.

14. The multilayer fuel line of claim 1, further comprising:
a first adhesive layer disposed between the liner layer and the barrier layer that physically bonds the barrier layer to the liner layer; and
a second adhesive layer disposed between the barrier layer and the cover layer that physically bonds the cover layer to the barrier layer,
wherein the first and second adhesive layers each comprise a thermoplastic polymer.

15. The multilayer fuel line of claim 1, wherein the multilayer fuel line is configured to withstand temperatures in a range of greater than or equal to about-40 degrees Celsius to less than or equal to about 130 degrees Celsius.

16. A multilayer fuel line comprising:
a liner layer having an inner circumferential surface defining a tubular flowthrough passage extending in an axial direction through the multilayer fuel line;
an intermediate layer circumferentially surrounding the liner layer, the intermediate layer comprising an aliphatic polyamide;
a barrier layer circumferentially surrounding the intermediate layer, the barrier layer comprising ethylene vinyl alcohol; and
a cover layer circumferentially surrounding the barrier layer and defining an outer circumferential surface of the multilayer fuel line, the cover layer comprising an aliphatic polyamide,
wherein the liner layer has a composite structure comprising a continuous matrix phase and a dispersed phase distributed throughout the continuous matrix phase,
wherein the continuous matrix phase comprises poly(nonamethylene terephthalamide) and the dispersed phase comprises an electrically conductive agent, and
wherein the electrically conductive agent provides the inner circumferential surface of the liner layer with a surface resistivity of less than or equal to about 1×10⁶ Ohms per square at 20 degrees Celsius.

17. The multilayer fuel line of claim 16, wherein the poly(nonamethylene terephthalamide) of the liner layer provides the inner circumferential surface of the liner layer with chemical resistance and low oligomer extraction against volatile liquid fuels.

18. The multilayer fuel line of claim 16, wherein the barrier layer creates a seal that circumferentially surrounds the tubular flowthrough passage and prevents fuel vapors from permeating through the multilayer fuel line and escaping to an external ambient environment.

19. The multilayer fuel line of claim 16, wherein the intermediate layer, the barrier layer, and the cover layer are electrically insulating and have surface resistivities of greater than 1×10⁶ Ohms per square at 20 degrees Celsius.

20. The multilayer fuel line of claim 16, wherein the multilayer fuel line is substantially free of perfluoroalkyl substances, polyfluoroalkyl substances, and combinations thereof, and wherein the multilayer fuel line is configured to withstand temperatures in a range of greater than or equal to about −40 degrees Celsius to less than or equal to about 130 degrees Celsius.
